(19) United States
(12) Patent Application Publication
(10) Pub. No.: US 2026/0276262 A1
(43) Pub. Date: Sep. 17, 2026

(54) THERMOELECTRIC MODULE AND REFRIGERATOR INCLUDING SAME

(71) Applicant: SAMSUNG ELECTRONICS CO., LTD., Suwon-si (KR)

(72) Inventors: Youngno KIM, Suwon-si (KR); Minsoo KIM, Suwon-si (KR); Junwoo SUH, Suwon-si (KR); Sungjin JUNG, Suwon-si (KR)

(73) Assignee: SAMSUNG ELECTRONICS CO., LTD., Suwon-si (KR)

(21) Appl. No.: 19/676,383

(22) Filed: May 13, 2026

Related U.S. Application Data
(63) Continuation of application No. PCT/KR2024/095216, filed on Feb. 15, 2024.

(30) Foreign Application Priority Data
Nov. 13, 2023 (KR) 10-2023-0156420

(51) Int. Cl. F25B 21/02

(52) U.S. Cl. CPC F25B 21/02

(57) ABSTRACT

A thermoelectric module includes: a first heat dissipation plate; a second heat dissipation plate, wherein the first heat dissipation plate and the second heat dissipation plate face opposite directions; and a Peltier element interposed between and contacting the first heat dissipation plate and the second heat dissipation plate, wherein each of the first heat dissipation plate and the second heat dissipation plate includes a thermal radiation coating layer formed on a surface thereof for radiation cooling, wherein the thermal radiation coating layer includes: oxide particles, and a thermal radiation material comprising a high-emissivity polymer compound, wherein the thermal radiation material surrounds the oxide particles through self-assembly.

### CROSS-REFERENCE TO RELATED APPLICATIONS

This application is a by-pass continuation application of International Application No. PCT/KR2024/095216, filed on Feb. 15, 2024, which is based on and claims priority to Korean Patent Application No. 10-2023-0156420, filed on Nov. 13, 2023, in the Ministry of Intellectual Property, the disclosures of which are incorporated by reference herein their entireties.

### BACKGROUND

### 1. Field

The present disclosure relates to a thermoelectric module and a refrigerator including the same, and more particularly, to a thermoelectric module including a thermal radiation coating layer and a refrigerator including the same.

### 2. Description of Related Art

As a refrigerator becomes more direct and smaller, a technology capable of efficiently dissipating heat generated within the refrigerator to an outside is becoming increasingly necessary. When internal heat is accumulated, the efficiency and durability of the refrigerator may be reduced, and may negatively impact its overall lifespan. Therefore, dissipating internal heat to the outside is crucial, and there are three methods such as conduction, convection, and radiation.

### SUMMARY

Provided are a thermoelectric module including a coating layer, in which a property of dissipating heat in a form of radiation is maximized and a surface area is increased to provide an effective cooling effect, and a refrigerator including the same. Additional aspects of the disclosure will be set forth in part in the description which follows and, in part, will be obvious from the description, or may be learned by practice of the disclosure.

According to an aspect of the present disclosure, a thermoelectric module includes: a first heat dissipation plate; a second heat dissipation plate, wherein the first heat dissipation plate and the second heat dissipation plate face opposite directions; and a Peltier element interposed between and contacting the first heat dissipation plate and the second heat dissipation plate, wherein each of the first heat dissipation plate and the second heat dissipation plate includes a thermal radiation coating layer formed on a surface thereof for radiation cooling, wherein the thermal radiation coating layer includes: oxide particles, and a thermal radiation material comprising a high-emissivity polymer compound, wherein the thermal radiation material surrounds the oxide particles through self-assembly.

According to an aspect of the present disclosure, a refrigerator includes a main body comprising a storage compartment, wherein the main body includes a heat dissipation plate, wherein the heat dissipation plate includes a thermal radiation coating layer on a surface thereof configured for radiation cooling, wherein the thermal radiation coating layer includes: oxide particles, and a thermal radiation material comprising a high-emissivity polymer compound, and wherein, at a surface of the thermal radiation coating layer, the thermal radiation material surrounds the oxide particles through self-assembly.

A thermoelectric module may include: a first heat dissipation plate and a second heat dissipation plate arranged in opposite directions, and a Peltier element interposed between and contacting the first heat dissipation plate and the second heat dissipation plate. Each of the first heat dissipation plate and the second heat dissipation plate may include a thermal radiation coating layer formed on a surface thereof for radiation cooling. The thermal radiation coating layer may include an oxide particle and a thermal radiation material containing a high-emissivity polymer compound. A surface of the thermal radiation coating layer may include a structure in which the thermal radiation material surrounds the oxide particle through self-assembly. Accordingly, by forming the thermal radiation coating layer containing the oxide particle and the high-emissivity polymer compound on the surface of the heat dissipation plate, a direction of heat emission may be controlled, and a difference in density between the oxide particle and the thermal radiation material may be controlled to allow the thermal radiation coating layer to have a large surface area through self-assembly. Therefore, it is possible to improve the efficiency of the radiation cooling of the thermoelectric module.

Further, a refrigerator may include a main body including a storage compartment. The main body may include a heat dissipation plate. The heat dissipation plate includes a thermal radiation coating layer formed on a surface thereof for radiation cooling. The thermal radiation coating layer may include an oxide particle and a thermal radiation material containing a high-emissivity polymer compound. A surface of the thermal radiation coating layer may include a structure in which the thermal radiation material surrounds the oxide particle through self-assembly. Accordingly, by forming the thermal radiation coating layer containing the oxide particle and the high-emissivity polymer compound on the surface of the heat dissipation plate, a direction of heat emission may be controlled, and a difference in density between the oxide particle and the thermal radiation material may be controlled to allow the thermal radiation coating layer to have a large surface area through self-assembly. Therefore, it is possible to improve the efficiency of the radiation cooling of the thermoelectric module. Further, the difficulty of cooling efficiency being affected by changes in characteristics of a medium for conduction and convection in cooling the heat generated in the refrigerator may be solved. Further, a power device for forced convection, which is required to compensate for a cooling performance of the heat dissipation plate with poor radiant heat dissipation capacity due to a very low emissivity, may be omitted.

Additional aspects of the disclosure will be set forth in part in the description which follows and, in part, will be obvious from the description, or may be learned by practice of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a cooling method of a surface of a refrigerator main body according to a related art refrigerator;

FIG. 2 is an enlarged view of a surface of a refrigerator main body in which a thermal radiation coating layer including a high-emissivity thermal radiation material and an oxide particle is applied to a surface of a heat dissipation plate according to an embodiment of the present disclosure, and a cooling method of a surface of the refrigerator;

FIG. 3 is a cross-sectional view of a state in which the thermal radiation coating layer including the high-emissivity thermal radiation material and the oxide particle is applied to a thermoelectric element and the refrigerator according to an embodiment of the present disclosure;

FIG. 4 is a graph showing an emissivity by measuring an absorption of the thermal radiation material according to an embodiment of the present disclosure by Fourier Transform Infrared spectroscopy (FT-IR); and

FIG. 5 is a graph showing temperatures over time of Peltier elements to which one example of the present disclosure and a comparative example are applied.

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements. The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items. Terms such as “1st”, “2nd”, “primary”, or “secondary” may be used simply to distinguish an element from other elements, without limiting the element in other aspects (e.g., importance or order). Further, as used in the disclosure, the terms “front”, “rear”, “top”, “bottom”, “side”, “left”, “right”, “upper”, “lower”, and the like are defined with reference to the drawings, and are not intended to limit the shape and position of any element.

When the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element. When an element is referred to as being “on” another element, it may be directly on the other element or intervening elements may also be present.

According to an embodiment of the disclosure, a refrigerator may include a main body. The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of −20 degrees Celsius to −1 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

According to an embodiment of the disclosure, the refrigerator may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

According to an embodiment of the disclosure, the refrigerator may include a cold air supply device for supplying cold air to the storage compartment.

The “cold air supply device” may include a machine, an apparatus, an electronic device, or a combination of those elements, and may be capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

According to an embodiment of the disclosure, the refrigerator may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

According to an embodiment of the disclosure, the refrigerator may include a dispenser provided on the door to provide water and/or ice. The dispenser may be provided on the door to allow access by the user without opening the door.

According to an embodiment of the disclosure, the refrigerator may include an ice-making device that produces ice. The ice-making device may include an ice-making tray that stores water, an ice-moving device that separates ice from the ice-making tray, and an ice-bucket that stores ice produced in the ice-making tray.

According to an embodiment of the disclosure, the refrigerator may include a controller for controlling the refrigerator. The “controller” may include a memory for storing and/or recording data and/or programs for controlling the refrigerator, and a processor for outputting control signals for controlling the cold air supply device, etc. in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data memorized/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

According to an embodiment of the disclosure, the refrigerator may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, a thermoelectric module and a refrigerator including the same will be described in detail with reference to the accompanying drawings.

According to an embodiment of the present disclosure, a thermoelectric module may include a first heat dissipation plate and a second heat dissipation plate arranged in opposite directions, and a Peltier element interposed between and contacting the first heat dissipation plate and the second heat dissipation plate. Each of the first heat dissipation plate and the second heat dissipation plate may include a thermal radiation coating layer formed on a surface thereof for radiation cooling. The thermal radiation coating layer may include an oxide particle and a thermal radiation material containing a high-emissivity polymer compound. A surface of the thermal radiation coating layer may include a structure in which the thermal radiation material surrounds the oxide particle through self-assembly.

In the present disclosure, a thermoelectric module means an electronic component that generates a Peltier effect, in which when a P-type element and an N-type element are connected in series and a direct current is applied to both ends, a carrier of each element absorbs heat at one end and transfers the absorbed heat to the other end and thus one end of each element is cooled and the other end is heated. The thermoelectric module has the advantages of being highly reliable, not generating noise or vibration, and performing local cooling, and may be applied to local cooling of electronic devices such as infrared sensors, laser diodes, and CCD elements, or IC products, and may be used in various fields such as scientific measuring equipment, medical equipment, refrigerators, air conditioners, and heat exchangers.

In general, in the case of a thermoelectric element that forms a thermoelectric module (TEM), that is a Peltier element, a temperature difference occurs on both sides when a voltage is applied. At this time, cooling is performed using cold air in a cold side, but when a temperature in a hot side continues to rise, the heat is transferred back to the cold side, which reduces efficiency. The present disclosure may ease a difficulty of reducing cooling efficiency as described above by applying a thermal radiation coating layer for radiation cooling to a heat dissipation plate of the hot side or the cold side, that is a surface of a heat sink in a thermoelectric module. Here, the heat dissipation plate may be used with the same meaning as a heat dissipation member, a cooling plate, a heating plate, a heat dissipation sheet, a heat sink, or a heat exchange plate. A cold side of the thermoelectric module, to which a first heat dissipation plate in the present disclosure may be applied, may be used with the same meaning as a heat absorption surface, a heat absorption portion, a heat absorption area, or a low-temperature portion, and a hot side of the thermoelectric module, to which a second heat dissipation plate may be applied, may be used with the same meaning as a heat generation surface, a heat generation portion, a heat generation area, or a high-temperature portion.

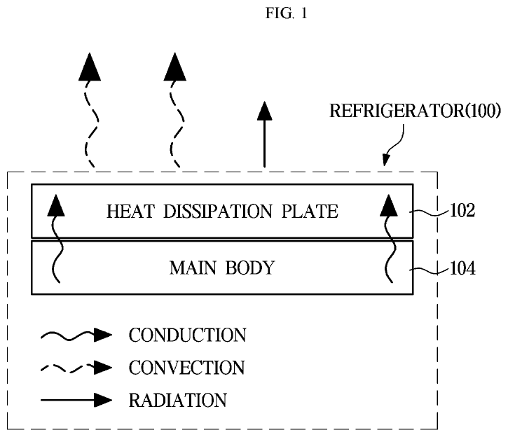

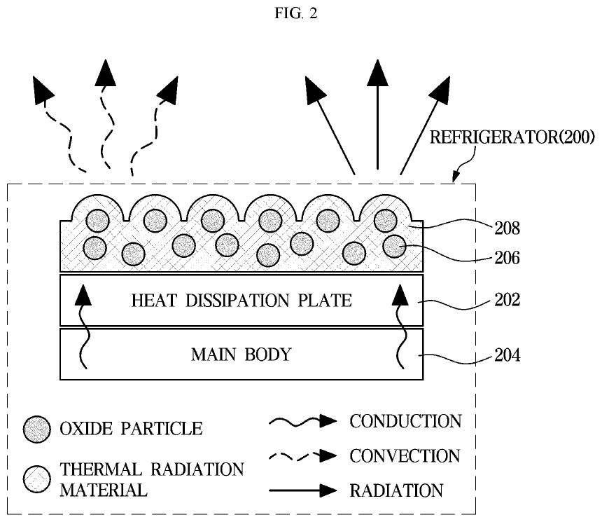

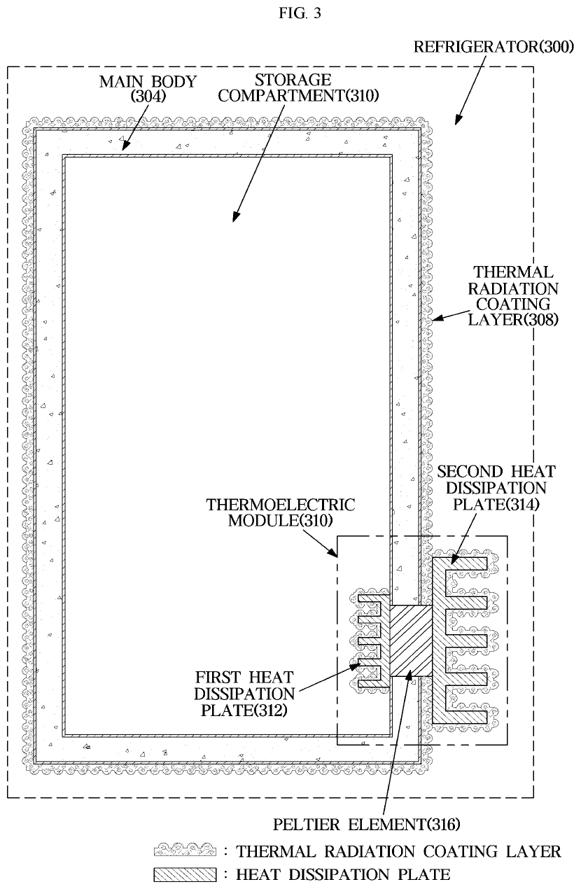

FIG. 1 is a view illustrating a cooling method of a surface of a refrigerator main body according to a related art refrigerator, FIG. 2 is an enlarged view of a surface of a refrigerator main body in which a thermal radiation coating layer including a high-emissivity thermal radiation material and an oxide particle is applied to a surface of a heat dissipation plate according to an embodiment of the present disclosure, and a cooling method of a surface of the refrigerator, and FIG. 3 is a cross-sectional view illustrating a state in which the thermal radiation coating layer including the high-emissivity thermal radiation material and the oxide particle is applied to a thermoelectric element and the refrigerator according to an embodiment of the present disclosure.

Referring to FIG. 1, in the case of a related art refrigerator, when heat is generated inside a refrigerator 100, the heat is transferred to a main body 104 of the refrigerator 100 and a heat dissipation plate 102 through conduction, and because the main body 104 of the refrigerator 100 uses a material with a low emissivity, such as aluminum, as a heat dissipation plate 102, it can be seen that a surface of the refrigerator is mostly cooled through convection, and heat dissipation through radiation is relatively small.

Referring to FIG. 2, in an embodiment of the present disclosure, a heat dissipation plate 202 formed of a material with a low emissivity may be applied to a main body of a refrigerator 200, and oxide particles 206 and a thermal radiation material 208 with a high emissivity may be applied to a surface of the heat dissipation plate 202, thereby maximizing a difference in emissivity between the heat dissipation plate 202 and the thermal radiation material 208 and controlling a directionality of heat dissipation to dissipate heat into the external atmosphere. In addition, after applying the oxide particles 206 and the thermal radiation material 208 with a high emissivity to the surface of the heat dissipation plate 202, phase separation is induced due to the difference in density, and thus the thermal radiation material 208 has a structure in which the thermal radiation material 208 surrounds the oxide particles 206 through self-assembly, thereby increasing a surface area of the oxide particles 206 and the thermal radiation material 208 by more than twice that before coating, thereby maximizing the cooling radiation effect and efficiently cooling the surface of the refrigerator 200. Here, the thermal radiation material 208 may be used with the same meaning as a heat-radiating material, a heat dissipation material, a heat dissipation member or a thermal radiation member, and the structure in which the thermal radiation material 208 surrounds the oxide particles 206 means a form in which the thermal radiation material 208 covers the surface of the oxide particles 206, and may include a core-shell form. In addition, in the present disclosure, the oxide is a general term for a binary compound of oxygen and another element, and in the case of the oxide particles 206 in the present disclosure, it may be used as a meaning including a very small object forming a material including the oxygen compound, that is, elementary particles, atoms, molecules, colloids, and the like. The oxide particles 206 may be used with the same meaning as an oxygen compound, oxide or oxidant. In the case of the heat dissipation plate 202 and the thermal radiation material 208 including oxide particles 206 applied according to the embodiment shown in FIG. 2, the application is not necessarily limited to the embodiment disclosed in the present disclosure, and may be applied without limitation to electronic devices or components such as thermoelectric modules, air conditioners, TVs, mobile phones, washing machines, and computers that require heat dissipation or cooling.

Referring to FIG. 3, in an embodiment of the present disclosure, a refrigerator 300 may include a main body 304 including a storage compartment 320. The main body 304 may include a thermoelectric module 310 which may include a first heat dissipation plate 312 and a second heat dissipation plate 314 arranged in or facing opposite directions, and a Peltier element 316 interposed between and contacting the first heat dissipation plate 312 and the second heat dissipation plate 314. Each of the first heat dissipation plate 312 and the second heat dissipation plate 314 may include a thermal radiation coating layer 308 formed on a surface thereof for radiation cooling. The thermal radiation coating layer may include an oxide particle and a thermal radiation material containing a high-emissivity polymer compound. Accordingly, a difference in emissivity between the heat dissipation plates and the thermal radiation material may be maximized, thereby controlling the directionality of heat dissipation and maximizing the cooling efficiency of heat generated within the refrigerator.

According to an embodiment of the present disclosure, in the thermoelectric module, the thermal radiation material may include a polymer compound including at least one bond selected from a group consisting of a carbon-oxygen single bond, a carbon-nitrogen single bond, a carbon-hydrogen single bond, a sulfur-oxygen double bond, a carbon-oxygen-carbon single bond, an oxygen-silicon-oxygen single bond, and an oxygen-hydrogen single bond. The thermal radiation material may include at least one selected from a group consisting of poly (3,4-ethylenedioxythiophene), poly(3,4-ethylenedioxythiophene) polystyrene sulfonate, MXene, graphene, single-walled carbon nanotube, multi-walled carbon nanotube, polyvinylidene fluoride, and polydimethylsiloxane.

Table 1 below shows a unique wavelength of emitted heat energy by Phononic vibration according to the type of molecular bond.

TABLE 1

| | Wavelength of emitted | |
|---|---|---|
| Bond | heat energy | |
| Carbon-oxygen single bond (C—O) | 7.7-10 | (μm) |
| Carbon-nitrogen single bond (C—N) | 8.2-9.8 | (μm) |
| Carbon-hydrogen single bond (C—H) | 7.8-14.5 | (μm) |
| Sulfur-oxygen double bond (S═O) | 9.4-9.8 | (μm) |
| Carbon-oxygen-carbon single bond | 8-13 | (μm) |
| (C—O—C) | | |
| Oxygen-silicon-oxygen single bond | 8.8-10 | (μm) |
| (O—Si—O) | | |
| Oxygen-hydrogen single bond (O—H) | 8-13 | (μm) |

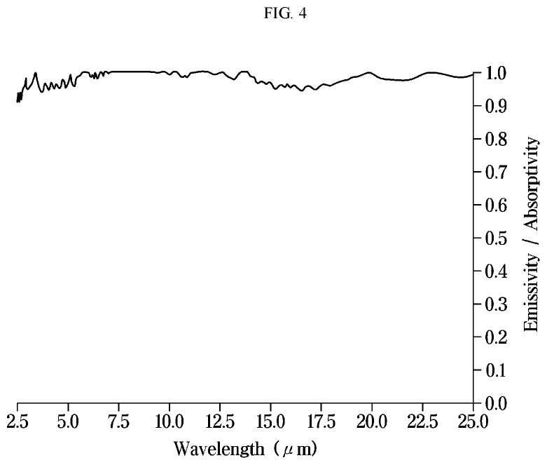

In the case of the thermal radiation material of the present disclosure, one or more of the bonds disclosed in Table 1 may be included in the molecular structure, and each bond has its own wavelength range of emitted heat energy due to the Phononic vibration phenomenon. Phononic vibration refers to a vibration phenomenon according to the characteristic of absorbing and emitting a wavelength range of heat energy unique to each functional group bonding structure. The present disclosure may secure high emissivity characteristics by selecting a bonding structure having such a unique wavelength range of heat energy and applying the bonding structure to the material of the present disclosure. FIG. 4 is a graph illustrating an emissivity by measuring an absorption of the thermal radiation material according to an embodiment of the present disclosure by Fourier Transform Infrared spectroscopy (FT-IR). Emissivity refers to an efficiency of energy emission from the surface of an object during thermal radiation. Thermal radiation is electromagnetic radiation and includes both visible light visible to the human eye and invisible infrared radiation. Quantitatively, emissivity is a ratio of heat radiated by a material to the heat radiated by an ideal blackbody surface at the same temperature, according to the Stefan-Boltzmann law. The ratio varies from 0 (zero) to 1, and the surface of a blackbody emits 448 W of thermal radiation per square meter at room temperature (25° C., 298.15K). Real objects with an emissivity less than 1 emit radiation at a lower rate. Kirchhoff's Law states that an amount of thermal radiation absorbed by an object is equal to an amount of thermal radiation emitted by the same object. According to Kirchhoff's Law, emissivity may be defined as the ratio of emissivity to absorptivity, as shown on the y-axis in FIG. 4.

Referring to FIG. 4, in the case of a thermal radiation material including the bonds disclosed in Table 1 in the molecule thereof, the thermal radiation material exhibits an emissivity of 0.9 or more and less than 1 in a wavelength range of heat energy of 2.5 μm or more and 25.0 μm or less. When the polymer compound included in the thermal radiation material of the present disclosure includes the bonds disclosed in Table 1 in its molecular structure, the thermal radiation material has a high emissivity of 0.9 or more in a wavelength range of heat energy of 2.5 to 25.0 μm, which is a region emitted by objects having a temperature of 300 K to 400 K, as well as in a wavelength range of infrared heat energy of sunlight and atmospheric radiation of 8 to 13 μm, which is an atmospheric window that may not be absorbed by atmospheric layers including greenhouse gases. Accordingly, it is possible to obtain excellent cooling efficiency in the thermoelectric module used in indoor environments and the refrigerator including the same.

In the present disclosure, a polymer compound may mean a compound having a molecular weight of 10,000 or more, and ceramics, carbon compounds, and the like may correspond to the polymer compound. However, the polymer compound is not necessarily limited to these examples, and any compound that may include a bond in Table 1 in the molecule thereof and has a molecular weight of 10,000 or more may correspond to the polymer compound of the present disclosure.

According to an embodiment of the present disclosure, the thermoelectric module may include at least one oxide particle selected from a group consisting of silica, alumina, copper oxide, antimony tin oxide, zinc oxide, and titanium oxide, and a density of the oxide particle may have a value that exceeds a density of the thermal radiation material by 1 g/cm³ or more.

TABLE 2

| Material | Role | Density (g/cm³) |
|---|---|---|
| PEDOT, PEDOT:PSS | Thermal radiation | 1 |
| Mxene | material | ~3 |
| Graphene | | 2.3 |
| SWCNT, MWCNT | | 1~2 |
| PVDF | | 1.8 |
| PDMS | | 1 |
| SiO₂ | Oxide | 2.6 |
| Alumina | | 3.6~3.9 |
| Copper oxide | | 6.3 |
| Antimony tin oxide | | 6.8 |
| Zinc oxide | | 5.6 |
| Titanium oxide | | 4.2 |

In the case of the present disclosure, the thermal radiation material and oxide of Table 2 are selected to allow the density of the oxide particle to have a value that exceeds a density of the thermal radiation material by 1 g/cm³ or more, thereby inducing self-assembly of the thermal radiation material and the oxide particles on the surface of the thermal radiation coating layer, thereby maximizing the surface area of the thermal radiation coating layer. Particularly, the thermal radiation material and the oxide particles having a density greater than that of the thermal radiation material are dissolved or dispersed in a hydrophilic solvent such as water, methanol, ethanol, isopropanol, acetone, acetonitrile, dimethylformamide, and dimethyl sulfoxide, and then the mixed composition is applied to the surface of the heat dissipation plate, and the application process may be performed by a method such as spray, bar, dip, comma, slot die, gravure, micro-gravure, and flow. Thereafter, the thermal radiation coating layer may be formed on the surface of the heat dissipation plate through a process of drying the solvent by heat treatment at a temperature of 60° C. to 200° C., and different or more types of materials may be arranged on upper and lower portions of the thermal radiation coating layer by self-assembly by utilizing the difference in density between the thermal radiation material and the oxide particles. At this time, the solvent and the coating method in the process are not limited to the listed examples, and may be performed by a hydrophilic solvent and coating method that may exhibit the effects of the present disclosure. According to an embodiment of the present disclosure, in the thermoelectric module, the oxide particle may have a diameter of 50 nm or more and 500 μm or less. When the diameter of the oxide particle is less than 50 nm, the oxide particle may not form a particle structure having sufficient volume, and thus the surface area of the coating layer targeted by the present disclosure may not be secured. When the diameter of the oxide particle exceeds 500 μm, the number of particle structures having volume decreases, and thus the surface area of the coating layer targeted by the present disclosure may not be secured. Therefore, in an embodiment, the diameter of the oxide particles is greater than or equal to 50 nm and less than or equal to and 500 μm.

Referring to FIG. 2, when the oxide particles 206 satisfying the oxide particle diameter of the present disclosure are applied to the surface of the heat dissipation plate 202, the oxide particles 206 may form a particle structure having a sufficient volume, thereby securing the surface area of the coating layer, and thereby improving the efficiency of the radiation cooling of the coating layer.

According to an embodiment of the present disclosure, in the thermoelectric module, in a wavelength range of thermal energy of 2.5 μm or more and 25.0 μm or less, an emissivity of the heat dissipation plate may be greater than 0 (zero) and less than 0.1, and an emissivity of the thermal radiation material may be greater than 0.85 and less than 1 (for example, greater than 0.9 and less than 1). Referring to FIG. 2, the difference in emissivity between the heat dissipation plate 202 and the thermal radiation material 208 may be maximized to control the direction of the heat emission to the outside of the main body 204 of the refrigerator 200. In addition, referring to FIG. 4, the thermal radiation material having an emissivity greater than 0.9 may be secured in a wavelength range of greater than or equal to 2.5 μm and less than or equal to 25.0 μm, which is the standard of 300 K to 400 K radiant heat energy as described above.

According to an embodiment of the present disclosure, in the thermoelectric module, a surface emissivity after applying the thermal radiation coating layer may be 17 times or more the surface emissivity before applying the thermal radiation coating layer, and a surface area after applying the thermal radiation coating layer may be 2 times or more a surface area before applying the thermal radiation coating layer.

$$\dot{Q} = A \times [ \overline{ε} \times σ ( {T}^{4} - {T}_{amb}^{4} ) + U ( {T}_{c} - {T}_{amb} ) ] \qquad Equation ( 1 )$$

where, \dot{Q}: total cooling performance, A: surface area, ε̅: surface emissivity, σ: Stefan-Boltzmann constant (5.67×10⁻⁸ W/m² K⁻⁴), Tc: surface temperature, Tamb: ambient temperature, U: total thermal conductivity.

An emissivity of an aluminum heat dissipation plate that is not coated with a thermal radiation material such as the present disclosure is 0.05, and the emissivity of the thermal radiation material of the present disclosure exceeds 0.9. Accordingly, it can be seen that the surface emissivity after applying the thermal radiation coating layer according to the embodiment of the present disclosure is improved by more than 17 times compared to the surface emissivity before application. In addition, by including the oxide particles in the coating layer to form the particle structure having volume and increasing the roughness of the surface, the surface area more than twice the surface area before applying the thermal radiation material may be secured.

According to Equation (1), in the case of the embodiment of the present disclosure, the surface emissivity may be secured to be 17 times or more than before application of the thermal radiation coating layer, and the surface area may be secured to be 2 times or more, thereby improving the cooling efficiency of the heat generated in the refrigerator.

According to an embodiment of the present disclosure, the thermoelectric module may include a thermal radiation coating layer having a thickness of 100 nm or more and 500 nm or less. When the thermal radiation coating layer has a thickness of less than 100 nm, the thermal radiation performance desired by the present disclosure may not be secured, and when the thermal radiation coating layer has a thickness exceeding 500 nm, the thermal conductivity decreases, thereby reducing the overall cooling efficiency. Therefore, in an embodiment, the thickness of the thermal radiation coating layer is greater than or equal to 100 nm and less than or equal to 500 nm.

According to an embodiment of the present disclosure, the thermoelectric module may include a heat dissipation plate formed of aluminum or copper, but is not necessarily limited to these examples, and any material that may be applied to the thermoelectric module and have an emissivity of more than 0 and less than 0.1 at a wavelength of heat energy of greater than or equal to 2.5 μm and less than or equal to 25.0 μm may correspond to the heat dissipation plate of the present disclosure.

According to an embodiment of the present disclosure, a refrigerator may include a main body including a storage compartment, the main body may include a heat dissipation plate, and the heat dissipation plate may include a thermal radiation coating layer formed on a surface thereof for radiation cooling, the thermal radiation coating layer may include an oxide particle and a thermal radiation material containing a high-emissivity polymer compound, and a surface of the thermal radiation coating layer may include a structure in which the thermal radiation material surrounds the oxide particle by self-assembly. As shown in FIG. 3 and the above, by applying the thermal radiation coating layer for the radiation cooling to the heat dissipation plate of the main body of the refrigerator, heat generated in the refrigerator may be efficiently radiantly cooled.

As for the refrigerator according to an embodiment of the present disclosure, the main body may further include a hole and a thermoelectric module in which a Peltier element is mounted on an edge of the hole. The thermoelectric module may include a first heat dissipation plate arranged to face an inside of a storage compartment and a second heat dissipation plate arranged to face an outside of the storage compartment, and the first heat dissipation plate and the second heat dissipation plate may include a thermal radiation coating layer on surfaces thereof. As mentioned above, by applying the thermal radiation coating layer to the heat dissipation plate of the thermoelectric module as well as the heat dissipation plate of the main body of the refrigerator, the efficiency the radiation cooling of the refrigerator may be maximized.

According to an embodiment of the present disclosure, a refrigerator may include a thermal radiation material including at least one selected from a group consisting of poly (3,4-ethylenedioxythiophene), poly(3,4-ethylenedioxythiophene) polystyrene sulfonate, MXene, graphene, single-walled carbon nanotube, multi-walled carbon nanotube, polyvinylidene fluoride, and polydimethylsiloxane, and the oxide particle may include at least one selected from a group consisting of silica, alumina, copper oxide, antimony tin oxide, zinc oxide, and titanium oxide. As described above, a coating solution containing a mixture of thermal radiation material and oxide particles may be applied to the heat dissipation plate applied to the main body of the refrigerator and the first and second heat dissipation plates of the thermoelectric module, thereby forming a coating layer with a surface area more than twice as large through self-assembly, thereby obtaining improved efficiency of radiation cooling compared to related art refrigerators.

Hereinafter the present disclosure will be described in detail through examples.

A comparative example is a Peltier element including an aluminum heat dissipation plate attached to a surface. An example is a Peltier element formed in such a way that an aluminum heat dissipation plate is attached to a surface, and a composition containing graphene, poly(3,4-ethylenedioxythiophene) polystyrene sulfonate, and alumina in a 1:1:1 ratio by weight, respectively, is dispersed in a solvent containing water and acetone in a 1:1 ratio by weight, and then mixed, and then the mixed composition is sprayed onto the surface of the heat dissipation plate and heat-treated at 100° C. for 30 minutes.

A voltage of 20 V is applied to each Peltier element corresponding to the comparative example and the example for 30 minutes, and the temperature changes of the hot side and the cold side over time are measured with a thermometer, and are shown in Table 3. Here, the hot side refers to a center of the heat dissipation plate in which the temperature increases due to the heat generated by Seebeck effect of the Peltier element being transferred, and the cold side refers to the center of the element located opposite the hot side in which the temperature decreases.

TABLE 3

| | Temperature (° C.) | | | |
|---|---|---|---|---|
| Time | Example | | Comparative example | |
| (minutes) | Hot side | Cold side | Hot side | Cold side |
| 0 | 25 | 25 | 25 | 25 |
| 5 | 75 | 12 | 77 | 8 |
| 10 | 90 | 24 | 93 | 22 |
| 15 | 97 | 32 | 102 | 32 |
| 20 | 104 | 41 | 112 | 43 |
| 25 | 108 | 45 | 117 | 49 |
| 30 | 110 | 50 | 122 | 56 |

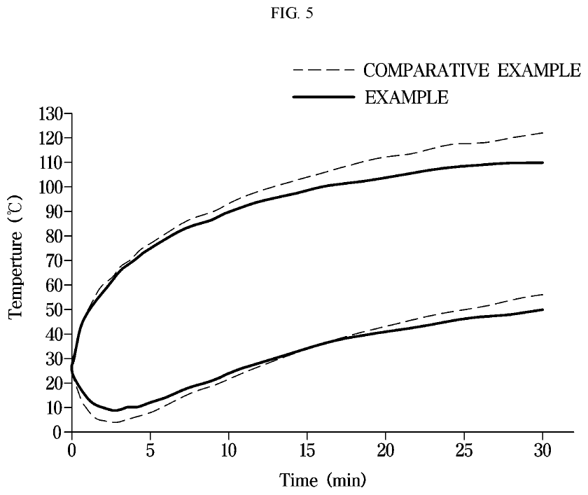

Referring to Table 3 and FIG. 5, in the case of the hot side of the Peltier element according to the example of the present disclosure, the element is heated due to the voltage application, reaching 90° C. after 10 minutes of voltage application, but cooling is performed by the material of the present disclosure, and the final temperature converges to 110° C. after 30 minutes of voltage application. On the other hand, in the case of the comparative example, a higher temperature is shown than in the example at all times after the voltage application, and the final temperature of the hot side is 122° C. after 30 minutes of voltage application, which is 12° C. higher than in the example, and unlike in the example of the present disclosure, the temperature of the hot side tends to rise even after 30 minutes. Similarly, in the case of the cold side of the Peltier element according to the example of the present disclosure, the element is heated due to the voltage application, reaching 32° C. after 15 minutes of voltage application, but cooling is performed by the material of the present disclosure, and the final temperature of the cold side of the element converges to 50° C. after 30 minutes of voltage application.

However, in the case of the cold side of the comparative example, it reaches 32° C. after 15 minutes of voltage application, and maintained a higher temperature than the example throughout the time thereafter. After 30 minutes, the cold side shows a final temperature of 56° C., which is 6° C. higher than the example of the present disclosure, and the emissivity characteristics are improved in the case of the example according to the present disclosure.

According to an embodiment, a thermoelectric module may include a first heat dissipation plate and a second heat dissipation plate arranged in opposite directions, and a Peltier element interposed between and contacting the first heat dissipation plate and the second heat dissipation plate. Each of the first heat dissipation plate and the second heat dissipation plate may include a thermal radiation coating layer formed on a surface thereof for radiation cooling. The thermal radiation coating layer may include an oxide particle and a thermal radiation material containing a high-emissivity polymer compound. A surface of the thermal radiation coating layer may include a structure in which the thermal radiation material surrounds the oxide particle through self-assembly.

The thermal radiation material may include a polymer compound containing at least one bond selected from a group consisting of a carbon-oxygen single bond, a carbon-nitrogen single bond, a carbon-hydrogen single bond, a sulfur-oxygen double bond, a carbon-oxygen-carbon single bond, an oxygen-silicon-oxygen single bond, and an oxygen-hydrogen single bond.

The thermal radiation material may include at least one selected from a group consisting of poly(3,4-ethylenedioxythiophene), poly(3,4-ethylenedioxythiophene) polystyrene sulfonate, MXene, graphene, single-walled carbon nanotube, multi-walled carbon nanotube, polyvinylidene fluoride, and polydimethylsiloxane.

The oxide particle may include at least one selected from a group consisting of silica, alumina, copper oxide, antimony tin oxide, zinc oxide, and titanium oxide.

A density of the oxide particle may have a value that exceeds a density of the thermal radiation material by 1 g/cm³ or more.

A diameter of the oxide particle may be greater than or equal to 50 nm and less than or equal to 500 μm.

An emissivity of the heat dissipation plate may be greater than 0 and less than or equal to 0.1, and an emissivity of the thermal radiation material may be greater than or equal to 0.85 and less than 1 in a wavelength range of heat energy of greater than or equal to 2.5 μm and less than or equal to 25.0 μm.

An emissivity of the heat dissipation plate may be greater than 0 and less than or equal to 0.1, and an emissivity of the thermal radiation material may be greater than or equal to 0.9 and less than 1 in a wavelength range of heat energy of greater than or equal to 2.5 μm and less than or equal to 25.0 μm.

An emissivity of a surface after applying the thermal radiation coating layer may be 17 times or more than an emissivity of the surface before application.

A surface area after applying the thermal radiation coating layer may be at least twice the surface area before the application.

A thickness of the thermal radiation coating layer may be greater than or equal to 100 nm and less than or equal to 500 nm.

The heat dissipation plate may include aluminum.

According to an embodiment, a refrigerator may include a main body including a storage compartment. The main body may include a heat dissipation plate. The heat dissipation plate includes a thermal radiation coating layer formed on a surface thereof for radiation cooling. The thermal radiation coating layer may include an oxide particle and a thermal radiation material containing a high-emissivity polymer compound. A surface of the thermal radiation coating layer may include a structure in which the thermal radiation material surrounds the oxide particle through self-assembly. In this way, by including the structure in which the thermal radiation material covers the oxide particle, the surface area of the coating layer may be increased, and not only the cooling effect due to conduction but also the cooling effect due to radiation may be maximized. Accordingly, it may be possible to secure the efficiency of cooling heat generated within the refrigerator without a medium or additional power, which is advantageous in terms of economy and energy efficiency.

The main body may further include a hole. The refrigerator may include a thermoelectric module provided to allow a Peltier element to be mounted on an edge of the hole. The thermoelectric module may include a first heat dissipation plate arranged to face an inside of the storage compartment, and a second heat dissipation plate arranged to face an outside of the storage compartment. Each of the first heat dissipation plate and the second heat dissipation plate may include a thermal radiation coating layer formed on a surface thereof.

The thermal radiation material may include at least one selected from a group consisting of poly(3,4-ethylenedioxythiophene), poly(3,4-ethylenedioxythiophene) polystyrene sulfonate, MXene, graphene, single-walled carbon nanotube, multi-walled carbon nanotube, polyvinylidene fluoride, and polydimethylsiloxane. The oxide particle may include at least one selected from a group consisting of silica, alumina, copper oxide, antimony tin oxide, zinc oxide, and titanium oxide.

Hereinbefore, a thermoelectric module and a refrigerator including the same according to an embodiment have been described.

While the present disclosure has been particularly described with reference to exemplary embodiments, those of skilled in the art may understand various changes in form and details may be made without departing from the spirit and scope of the present disclosure.

What is claimed is:

1. A thermoelectric module comprising:
a first heat dissipation plate;
a second heat dissipation plate, wherein the first heat dissipation plate and the second heat dissipation plate face opposite directions; and
a Peltier element interposed between and contacting the first heat dissipation plate and the second heat dissipation plate,
wherein each of the first heat dissipation plate and the second heat dissipation plate comprises a thermal radiation coating layer formed on a surface thereof for radiation cooling,
wherein the thermal radiation coating layer comprises:
oxide particles, and
a thermal radiation material comprising a high-emissivity polymer compound,
wherein the thermal radiation material surrounds the oxide particles through self-assembly.

2. The thermoelectric module of claim 1, wherein the high-emissivity polymer compound comprises at least one of: a carbon-oxygen single bond, a carbon-nitrogen single bond, a carbon-hydrogen single bond, a sulfur-oxygen double bond, a carbon-oxygen-carbon single bond, an oxygen-silicon-oxygen single bond, or an oxygen-hydrogen single bond.

3. The thermoelectric module of claim 1, wherein the thermal radiation material comprises at (3,4-least one of: poly(3,4-ethylenedioxythiophene), poly ethylenedioxythiophene) polystyrene sulfonate, MXene, graphene, single-walled carbon nanotube, multi-walled carbon nanotube, polyvinylidene fluoride, or polydimethylsiloxane.

4. The thermoelectric module of claim 1, wherein each the oxide particles comprises at least one of: silica, alumina, copper oxide, antimony tin oxide, zinc oxide, or titanium oxide.

5. The thermoelectric module of claim 1, wherein a density of the oxide particle is greater than a density of the thermal radiation material by at least 1 g/cm³.

6. The thermoelectric module of claim 1, wherein a diameter of the oxide particle is greater than or equal to 50 nm and less than or equal to 500 μm.

7. The thermoelectric module of claim 1, wherein an emissivity of the heat dissipation plate is greater than 0 and less than or equal to 0.1, and
wherein an emissivity of the thermal radiation material is greater than or equal to 0.85 and less than 1 in a wavelength range of heat energy of greater than or equal to 2.5 μm and less than or equal to 25.0 μm.

8. The thermoelectric module of claim 1, wherein an emissivity of the heat dissipation plate is greater than 0 and less than or equal to 0.1, and
wherein an emissivity of the thermal radiation material is greater than or equal to 0.9 and less than 1 in a wavelength range of heat energy of greater than or equal to 2.5 μm and less than or equal to 25.0 μm.

9. The thermoelectric module of claim 1, wherein an emissivity of a surface after applying the thermal radiation coating layer is at least 17 times more than an emissivity of the surface before applying the thermal radiation coating layer.

10. The thermoelectric module of claim 1, wherein a surface area after applying the thermal radiation coating layer is at least twice a surface area before applying the thermal radiation coating layer.

11. The thermoelectric module of claim 1, wherein a thickness of the thermal radiation coating layer is greater than or equal to 100 nm and less than or equal to 500 nm.

12. The thermoelectric module of claim 1, wherein the heat dissipation plate comprises aluminum.

13. A refrigerator comprising a main body comprising a storage compartment,
wherein the main body comprises a heat dissipation plate,
wherein the heat dissipation plate comprises a thermal radiation coating layer on a surface thereof configured for radiation cooling,
wherein the thermal radiation coating layer comprises:
oxide particles, and
a thermal radiation material comprising a high-emissivity polymer compound, and
wherein, at a surface of the thermal radiation coating layer, the thermal radiation material surrounds the oxide particles through self-assembly.

14. The refrigerator of claim 13, wherein the main body further comprises a hole,
wherein the refrigerator comprises a thermoelectric module,
wherein the thermoelectric module comprises:
a Peltier element mounted on an edge of the hole; and
the heat dissipation plate,
wherein the heat dissipation plate comprises:
a first heat dissipation plate arranged to face an inside of the storage compartment; and
a second heat dissipation plate arranged to face an outside of the storage compartment,
wherein each of the first heat dissipation plate and the second heat dissipation plate comprises the thermal radiation coating layer formed on a surface thereof, and
wherein the Peltier element is interposed between and contacts the first heat dissipation plate and the second heat dissipation plate.

15. The refrigerator of claim 13, wherein the thermal radiation material comprises at least one of: poly(3,4-ethylenedioxythiophene), poly(3,4-ethylenedioxythiophene) polystyrene sulfonate, MXene, graphene, single-walled carbon nanotube, multi-walled carbon nanotube, polyvinylidene fluoride, or polydimethylsiloxane, and
wherein the oxide particle comprises at least one of: silica, alumina, copper oxide, antimony tin oxide, zinc oxide, or titanium oxide.
